(19) United States
(12) Patent Application Publication
(10) Pub. No.: US 2002/0010000 A1
(43) Pub. Date: Jan. 24, 2002

(54) Knowledge-based information retrieval system and method for wireless communication device

(76) Inventors: Vincent Chern, San Diego, CA (US); William Y. Son, Poway, CA (US); Yuri A. Tijerino, San Diego, CA (US)

Correspondence Address: COLLIER, SHANNON, SCOTT, PLLC, 3050 K STREET, NW, SUITE 400, WASHINGTON, DC, 20007, US

(21) Appl. No.: 09/768,305

(22) Filed: Jan. 25, 2001

Related U.S. Application Data
(60) Provisional application No. 60/177,939, filed on Jan. 25, 2000.

(51) Int. Cl. H04B 7/00

(52) U.S. Cl. 455/517; 455/414

(57) ABSTRACT

A wireless knowledge-based information-retrieval system includes a wireless communication device. The wireless device has a transceiver for sending and receiving communications across a wireless communication network, a software agent responsible for quickly and efficiently accessing relevant information and providing it to a user, at least one knowledge database, and a position-determination device for determining the location of the wireless device. The software agent takes information requests from the user and communicates them via the wireless network and the Internet to a knowledge agency. The knowledge agency comprises individual knowledge agents that take the request and search for relevant information in information resources such as the Internet and electronic databases and directories. The knowledge agency transmits the information back to the software agent, which delivers it to the user. The software agent may be configured as a conversational agent in order to maintain a dialog with the user using natural language and mood control.

### FIELD OF THE INVENTION

The present invention relates generally to radio or wireless communications and, more particularly, relates to a knowledge-based information retrieval system and method thereof.

### BACKGROUND OF THE INVENTION

The advent of wireless personal communication devices has revolutionized the telecommunications industry. Cellular, PCS and other services provide wireless personal communications to businesses and individuals at home, in the office, on the road, and to any other locations the wireless network reaches. Wireless telephone subscribers no longer have to use pay telephones along the road, or wait until they return home or to the office, to check messages and return important business calls. Instead, wireless subscribers carry out their day to day business from their cars, from the jobsite, while walking along the airport concourse, and just about anywhere their signals are accessible.

Thus, it is no surprise that since the introduction of the cellular telephone service, the number of wireless telephone subscribers has increased steadily. Today, the number of wireless telephone subscribers is staggering and still growing rapidly. In fact, many households have multiple wireless telephones in addition to their conventional landline services.

With a market of this size, there is fierce competition among hardware manufacturers and service providers. In an attempt to lure customers, most providers offer handsets with desirable features or attributes such as small size, light weight, longer battery life, speed dial, and so forth. Many recent additions to the marketplace include multi-functional handsets that even provide pocket-organizer functions integrated into the wireless handset. Most manufacturers, however, are still scrambling to add new features to their communication devices to snare a portion of this booming market.

One feature that promises to take wireless communication devices to the next level in functionality is wireless access to the Internet and other electronic information sources. Many new handsets include Internet browsers and many wireless service providers plan to supply data services. The usefulness of these advancements, however, is limited in several ways. First, there can be too much information available. This has been referred to as “information overload.” Because current programs for accessing this information require manual navigation and control, the large amount of data becomes unwieldy in a wireless device.

To combat this problem, many wireless service providers limit the content to fixed information that is updated periodically. Though this strategy makes the information more manageable, it also severely limits the usefulness and availability of the information. A need exists for a method of accessing large amounts of data from a wireless communication device in a manner that allows users to quickly and efficiently obtain relevant and targeted information.

### SUMMARY OF THE INVENTION

The present invention is directed to a knowledge-based information retrieval system for a wireless communication device.

In one embodiment of the invention, a knowledge-based information retrieval system is provided. The system comprises a wireless communications network and a wireless communications device operating within the network. The wireless device includes a transceiver that sends and receives communications across the network, and a software client agent that receives an information request from a user of the device and retrieves information responsive to the request. A position determination device determines the location of the wireless device and provides the location to the client agent to assist in information retrieval. The wireless device also includes a knowledge database containing data of use to the client agent in information retrieval. A knowledge agency comprising multiple knowledge agents communicates with the client agent over the wireless network and accesses associated information resources to retrieve information that is responsive to the information request.

The present invention also provides a method for knowledge-based information retrieval in a wireless communications system. The method comprises the steps of:

(a) receiving an information request from a user of a wireless communications device;

(b) providing the information request to a software agent associated with the wireless communications device;

(c) providing data of relevance to the information request to the software agent;

(d) with the software agent, communicating the information request via the wireless network to a knowledge agency comprised of specialized knowledge agents;

(e) with the knowledge agency, searching appropriate information resources to retrieve information responsive to the information request;

(f) with the knowledge agency, communicating the retrieved information via the network to the software agent; and

(g) providing the retrieved information to the user of the wireless device.

A method for controlling dialog between a software agent associated with a wireless communications device and a user of the device is also provided. Dialog control is accomplished by

(a) receiving an input from the user;

(b) parsing the input;

(c) retrieving a list of potential replies to the input from stored templates and selecting a reply;

(d) initiating communication between the software agent and an outside knowledge agency to retrieve any information necessary to complete the reply; and

(e) providing the completed reply to the user.

Objects and advantages of the present invention include any of the foregoing, taken alone or in combination. Further objects and advantages will be apparent to those of ordinary skill in the art, or will be set forth in the following disclosure.

### BRIEF DESCRIPTION OF THE DRAWINGS

The present invention is described with reference to the accompanying drawings. In the drawings, like reference numbers indicate identical or functionally similar elements, and

FIG. 1 is a block diagram of a wireless communication device that may be used in accordance with an embodiment of the present invention.

FIG. 2 is a block diagram of a wireless communications system that may be used in accordance with an embodiment of the present invention.

FIG. 3 is a block diagram of the interaction between a software agent and a knowledge database in accordance with an embodiment of the present invention.

FIG. 4 is a block diagram of the interaction between a knowledge agency and information resources in accordance with an embodiment of the subject invention.

FIG. 5 is a block diagram illustrating another embodiment of a wireless communication device that may be used in accordance with an embodiment of the subject invention.

FIG. 6 is a process flow diagram illustrating a method for knowledge-based information retrieval according to an embodiment of the present invention.

FIG. 7 is a process flow diagram illustrating a method for communication between a conversational agent and a user according to an embodiment of the present invention.

FIG. 8 is a process flow diagram illustrating a short-term memory configuration used for control of agent-user dialog in accordance with an embodiment of the invention.

FIG. 9 is a process flow diagram illustrating an activation network used for control of agent-user dialog in accordance with an embodiment of the invention.

FIG. 10 is a process flow diagram illustrating a sub-template network used for control of agent-user dialog in accordance with an embodiment of the invention.

FIG. 11 is a process flow diagram illustrating a method for controlling the mood of an agent-user dialog in accordance with an embodiment of the invention.

### DETAILED DESCRIPTION OF PREFERRED EMBODIMENTS

1. Introduction and Overview

The present invention provides a knowledge-based information retrieval system and method for a wireless communication device. The wireless communication device incorporates a knowledge database of user preferences and other useful data, a position determination device, and a software agent. The device user interface permits a user to make a request for information, such as driving directions, restaurant locations, flight information, current news, and the like. Using the user request and information gleaned from the knowledge database and position determination device, the software agent consults with a knowledge agency comprised of specialized agents and retrieves a relevant and targeted response to the user's request. The agent may be configured as a conversational agent in order to carry on a friendly conversation with the user complete with natural language and mood control.

2. Example Environment

Before describing the invention in detail, it is useful to describe an example environment in which the invention can be implemented. One example environment is a handset or communication device operating within a wireless communication network such as, for example, a cellular, GSM, PCS or radio communication network. Wireless communication devices embodying the present invention can be implemented in various configurations and architectures. Typically, a wireless communication device will include a keypad for control of the device and data entry, and a display for displaying relevant information.

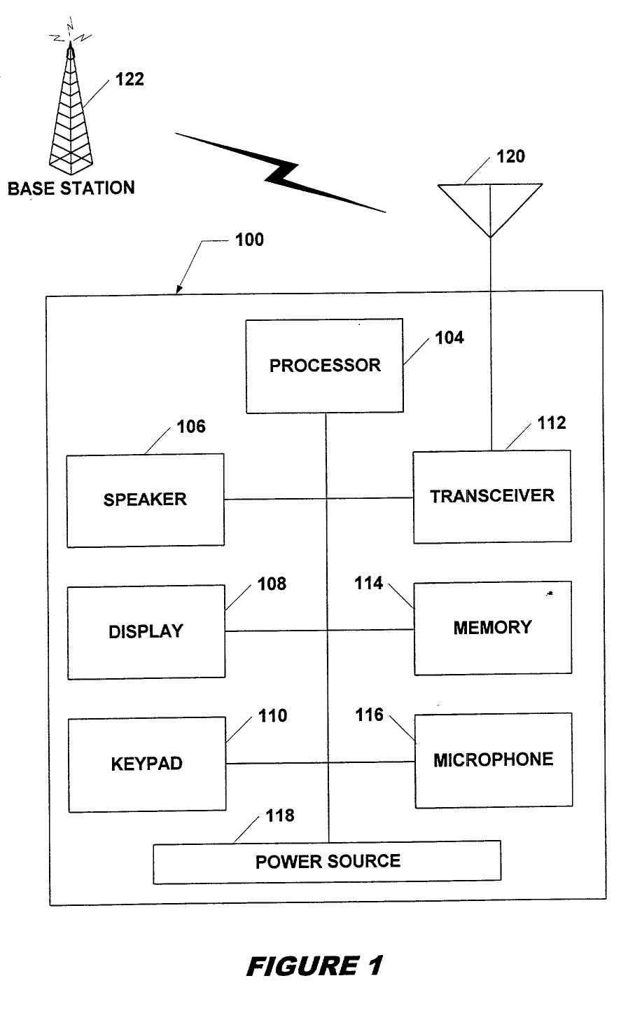

An example wireless communication device 100 is illustrated in FIG. 1. Device 100 is presented for illustrative purposes only; implementation of the invention is not dependent on any particular device architecture or communication network. Device 100, which is typically a mobile device such as a handheld handset or an integrated vehicle phone, includes a processor 104, a speaker 106, a display 108, a keypad 110, a transceiver 112, a memory 114, a microphone 116, a power source 118 and an antenna 120. It is configured to communicate with other communications devices such as base station 122. Base station 122 is typically within a geographic area known as a “cell” and handles communications for all wireless devices within the cell.

Processor 104 directs the overall operation of device 100. A computer program or set of instructions is typically coded or otherwise implemented on the processor to enable the processor to carry out the device operation. Memory 114 interfaces with processor 104 and may store program code and provide storage space for data useful in executing the program code and carrying out the device functions. Memory 114 may be implemented as ROM, RAM or any other convenient memory format.

Transceiver 112 includes a transmitter that transmits voice and data information via antenna 120 to a recipient communication device such as, for example, base station 122. Transceiver 112 also includes a receiver that receives voice and data information from another communication device (e.g., base station 122). The received voice and data information is provided to the user or used to facilitate device operation.

User interface features include speaker 106, display 108, keypad 110, and microphone 116. Microphone 116 accepts voice or other audio information from the user and converts this information into electrical signals that can be transmitted by transceiver 112. Likewise, speaker 106 converts electrical signals received by transceiver 112 into audio information that can be heard by a user of device 100. Voice recognition and speech synthesis capability can be included to provide an enhanced user interface allowing acceptance of a user's vocal commands and provides audible vocal responses. The enhanced interface may complement a conventional display and keypad interface.

Display 108 displays information such as call information, keypad entry information, signal presence and strength information, battery life information, or any other information useful to the user. Display 108 preferably takes the form of a liquid crystal display (LCD), which has low power consumption characteristics, but could also be implemented as a light emitting diode (LED) display or any other appropriate visual indicator.

Keypad 110 typically includes an alphanumeric keypad and may also include special function keys. In one embodiment, keypad 110 is backlit to permit viewing of the keys in low light or dark conditions. Device 100 may also include a flip panel (not shown) that can be closed to conceal some or all of the keypad.

Power source 118 provides power to device 100. It can be implemented with rechargeable batteries, such as NiCad or NiMH rechargeable batteries, or with any other suitable power source.

3. A Knowledge-Based Information Retrieval System

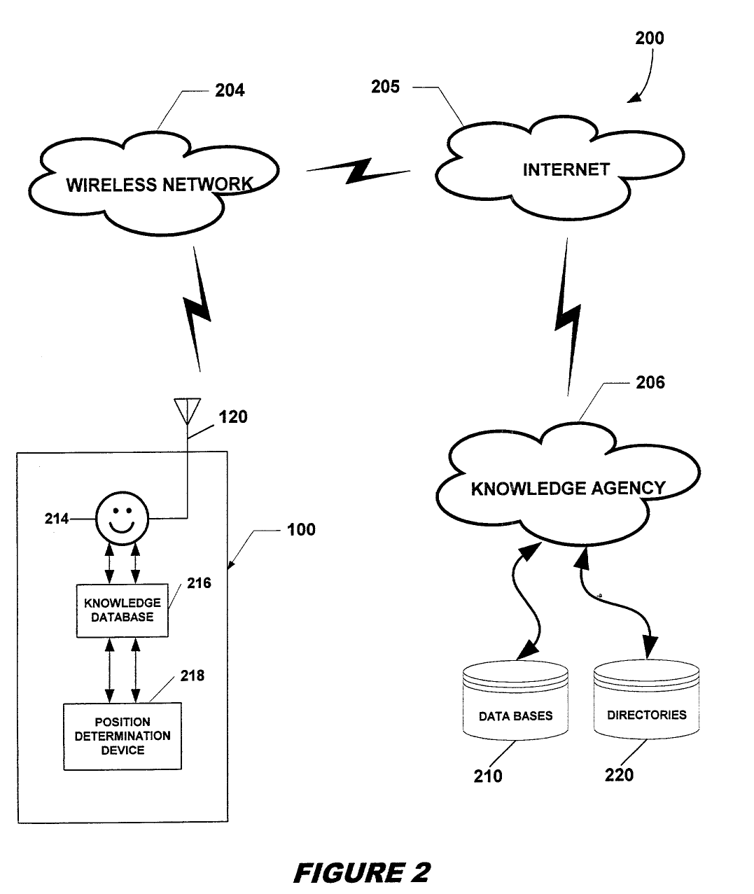

FIG. 2 is a block diagram illustrating a first embodiment of a wireless communication system 200 according to the present invention. System 200 comprises a wireless communications device 100 that may be configured as described above with reference to FIG. 1. Using software client agent 214, device 100 communicates over wireless network 204 with Internet 205 and at least one knowledge agency 206 to retrieve information that is relevant to a user's needs, location, destination and/or preferences. Knowledge agency 206 will typically reside on a server that is connected to Internet 205.

A software agent is a computer software program or package that autonomously carries out tasks delegated to it by others, such as human users or other computer programs or applications. It has exclusive control over its own actions without direction or control by an external entity. Moreover, an agent can react to changes in its environment and can communicate with other entities, such as other computer systems or other software agents. The design and operation of software agents is well known to those of ordinary skill in the art.

Client agent 214 can be thought of as a user interface that does more than respond to user manipulation. Agent 214 is an intelligent agent that is capable of perceiving its environment (i.e. wireless handset 100 and, more broadly, communications system 200) and responding in a timely fashion to perceived changes. Client agent 214 does not, however, simply react to the environment. It is also able to act in an opportunistic, goal-oriented manner and to take the initiative in seeking out relevant information when appropriate. Further, client agent 214 is able to interact with other agents or the user in order to complete its objective. Using information gathered from knowledge database 216, position determination device 218 and knowledge agency 206, agent 214 selectively searches and filters large amounts of data to provide only the data most relevant to a user at a particular time and location.

In one implementation, agent 214 is a software program that resides in memory 114 and is accessed by processor 104. Alternatively, agent 214 resides and is run directly from processor 104. In a still further alternative implementation, rather than residing in wireless device 100, agent 214 resides on Internet 205 or on a server connected to Internet 205. In any event, regardless of where agent 214 resides, it will communicate with both device 100 and knowledge agency 206 (which will typically reside on a server connected to Internet 205) via Internet 205 and wireless network 204.

An important distinction between agent software programs and typical software programs is that agent software programs autonomously determine whether and how they will carry out requests. The ability to learn is an important aspect of agent 214. It learns about the user by continually modeling facts about the user such as patterns of inquiry, favorite types of food, favorite types of movies and the like. Additionally, agent 214 learns about the environment in which it operates, in this case wireless communication system 200. This learned information, combined with direct user input and preferences, allows agent 214 to develop a “personality” in its interaction and task performance.

The primary resource that guides agent 214 is, of course, the specific information that is needed by the wireless handset user. Handset 100 is configured to accept user's requests for information and, if desired, to provide automated alerts about particular subjects or events. Though agent 214 may seek out virtually any type of information that may be needed by a wireless user, a few examples are listed below. Agent 214 may seek out entertainment information needed by the user such as nearby restaurants (prioritized by cuisine type, price, quality or other factors), times and reviews of movies being screened at nearby theaters, event and ticket information, listings of TV or radio programs and channels, golf tee times and so on. Agent 214 may also seek out useful travel information, such as airline flight status and reservations, hotel and car rental reservations, driving directions and traffic information. Financial information that may be desired by a user and obtainable by agent 214 includes information such as current stock quotes and trading information, or perhaps the location of the nearest ATM machine. Other useful information that may be sought by agent 214 includes yellow/white page listings, weather forecasts and news/sports stories.

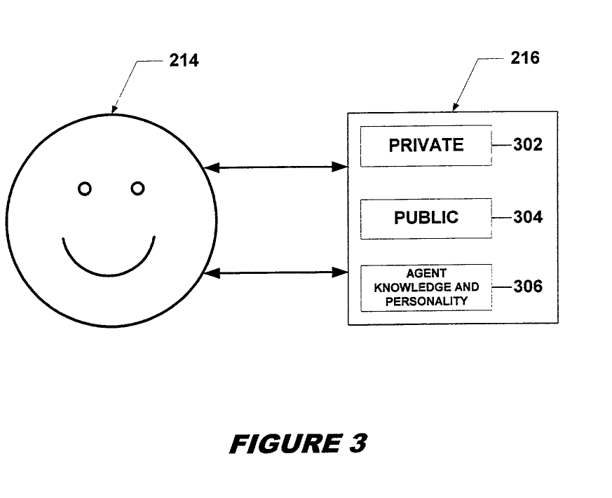

In addition to the actual user request, another resource used by agent 214 is knowledge database 216. In one implementation, knowledge database 216 is stored in memory 114 (FIG. 1) of communication device 100 and comprises three sub-databases 302, 304 and 306 (FIG. 3). Private database 302 stores information about a user such as the user's name, social security number, contacts, schedule, passwords, account information, private preferences and passwords. Private database 302 is a secure database and agent 214 does not share this information with other entities that it communicates with. Information such as preferences and passwords may be entered by the user directly into handset 100 or, alternatively, entered at a website or database in communication with handset 100. Public database 304 stores non-private information such as user taste preferences, item ratings, current interests and needs, and location information provided by position location device 218. Agent knowledge and personality database 306, as described above, comprises information gathered and learned by agent 214 as well as any information regarding the user's personality.

Position determination device 218, which determines the location of handset 100, is another resource utilized by agent 214. Position determination device 218 determines location in terms of parameters such as latitude, longitude, height, speed of travel, and any other useful location or position parameters. As noted above, this information may be stored in knowledge database 216 for access by agent 214. In one embodiment, position determination device 218 is implemented using a GPS (global positioning system) or differential GPS. The design and configuration of GPS is well known to those of ordinary skill in the art. Alternative position determination systems, such as a triangulation system, could also be utilized. The location information provided by position determination device 218 is used to form a dynamic reference point (DRP) that is stored in database 216 for consideration by agent 214 when carrying out its tasks. The user's route and destination may also be considered by agent 214 to increase the relevance of the information retrieved and provided to the user.

The user information request, in combination with information from database 216 and position determination device 218, permits agent 214 to quickly and efficiently obtain relevant and specifically targeted information. If the user wants to find a restaurant, for example, the agent may use this request in combination with the user's current location (provided by position determination device 218) and food preferences (provided by database 216) to quickly and efficiently find a nearby restaurant matching the user's tastes. If the user wants driving directions to a particular location, agent 214 may use this request in combination with the user's current location and user preferences (i.e. quickest route vs. most scenic route) in obtaining the driving directions.

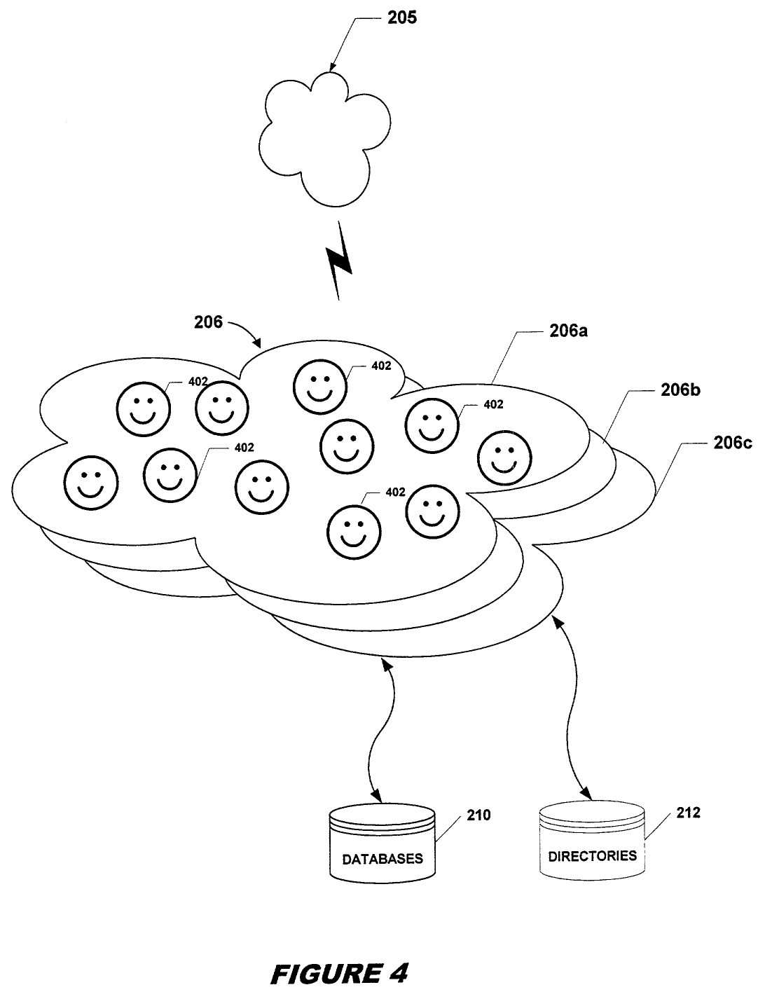

With the user request, the user's location and pertinent information from database 216, agent 214 communicates via wireless network 204 with Internet 205 and at least one knowledge agency 206. As shown in FIG. 4, knowledge agency 206 comprises a collection of individual knowledge agents 402 each possessing its own specialized knowledge and data. Once a request and other information is received from agent 214, knowledge agent(s) 402 having expertise related to the request are assigned to gather information responsive to the request. Agents 402 may access a number of resources in order to gather the necessary information. These include, but are not limited to, electronic databases 210 and directories 212 that agency 206 has access to. As shown in FIG. 4, agency 206 may include separate agencies 206a, 206b, and 206c each having a benchmark of expertise such as locality, subject matter or other criterion.

Agents 402 may use filtering methods such as information and collaborative filters to filter and identify the information that is of most use and relevance to the user. An information filter filters available information based on the user request and user information and preferences provided by client agent 214. One particular knowledge agent may search for and gather information on restaurants subject to the user preferences, for example, while a second knowledge agent searches for and gathers information on movie theaters. A collaborative filter gathers past ratings and experiences regarding a particular item, place or event from the various knowledge agents and uses this base of past experience to narrow the information to the best available choices. Agency-wide filters may also be used to further narrow the information provided by agents 402 and, in some implementations, agency 206 may apply an even higher level filter to narrow the information provided by a group of agencies 206a, 206b and 206c.

The responsive information gathered by agency 206 is transmitted over Internet 205 and communication network 204 to client agent 214. By distributing functionality in this fashion, the system is able to function beyond the capabilities of any one agent. System 200 can quickly and efficiently search for and provide the most relevant information. Further, client agent 214 can use data from agent knowledge database 306 to present the information in a manner personalized to the user. Thus, the user has access to large amount of information and obtains personalized relevant information, without manually controlling the searching operation.

The interface between the information sources 210,212 and knowledge agency 206 uses a suitable transport protocol for transmission of information requests and results. In one implementation, the TCP/IP protocol is used. TCP/IP and other suitable protocols are well known to those skilled in the art. For agent-to-agent and inter-agency communications, including communications between client agent 214 and knowledge agency 206, an inter-agent communication language is used. The agent communication language establishes common understandings for instructions, assertions, requests and the like, and also establishes a syntax for effective communication. Several such languages have been developed. While the invention is not dependent on any specific agent communication language, two notable examples are Knowledge Query and Manipulation Language (KQML) and Foundation for Intelligent Physical Agents—Agent Communication Language (FIPA-ACL).

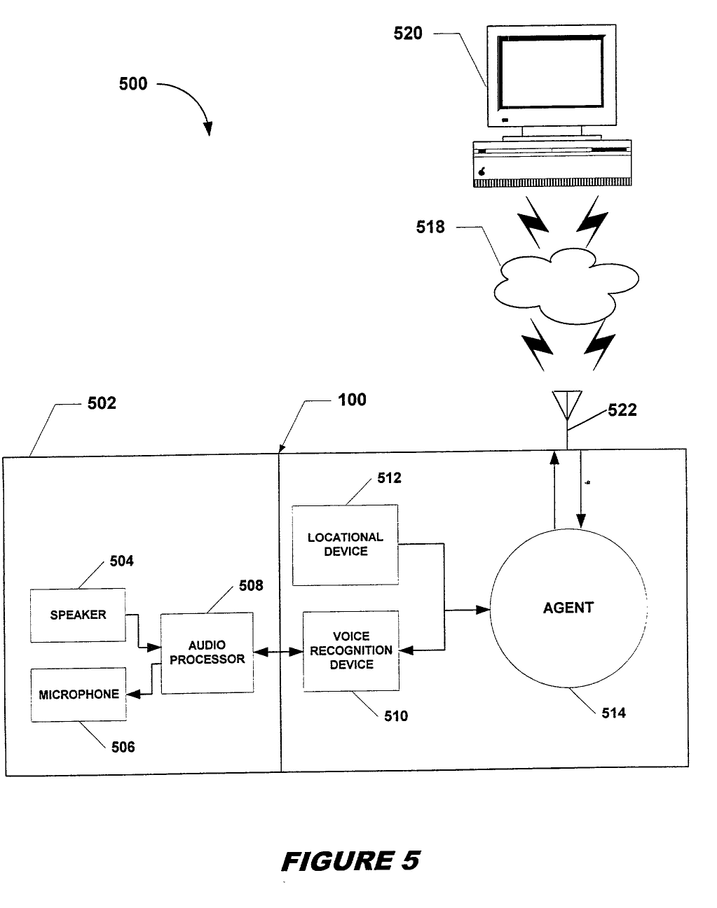

In one implementation, client agent 214 is a conversational agent with the ability to converse with, respond to and entertain the user. FIG. 5 illustrates a wireless communication system 500 including handset 100, communications network 518 and a remote computer or server 520. Handset 100 comprises conversational agent 514, a hands-free unit 502 and a voice recognition device 510. Hands-free unit 502 is used in conjunction with handset 100 to permit a user to provide voice requests and to receive voice responses. Hands-free unit 502 is especially useful when the user is in a car, as the user can interact with handset 100 and retrieve needed information using verbal commands and responses while keeping their hands and eyes free for attending to driving. Alternatively, the functionality provided by hands-free unit 502 may be incorporated directly into handset 100. Network 518 may comprise a wireless network with connectivity to the Internet.

Hands-free unit 502 includes a speaker 504, microphone 506 and audio processor 508. User speech commands are received by microphone 506, digitized by audio processor 508 and processed by voice recognition device 510. The design and configuration of audio processors and voice recognition devices are well known to those of ordinary skill in the art. Processed speech commands are provided by voice recognition device 510 to conversational agent 514, which then proceeds via antenna 522 over communication network 518 to a knowledge agency, such as knowledge agency 206 of FIG. 2. Knowledge agency 206 formulates a response to the user request and provides it to agent 514 via communications network 518. In one implementation, the response formulated by agency 206 is first provided to a speech synthesis service or device embodied in a computer or server 520. The speech synthesis service converts the response to digital voice data and transmits the data back to communication device 100, where it is processed by audio processor 508 and announced to the user via speaker 504.

Conversational agent 514 maintains a conversation with a user, provides information to the user and entertains the user by correlating the user's spoken language, personality and requests into appropriate answers and communicating with the user through natural language capabilities, dialog control and moods. As discussed in the previous implementations, the user personality is something the agent “learns” so that the agent can supply relevant, personalized information in response to user requests. Learned information regarding user personality is stored in agent knowledge database 306.

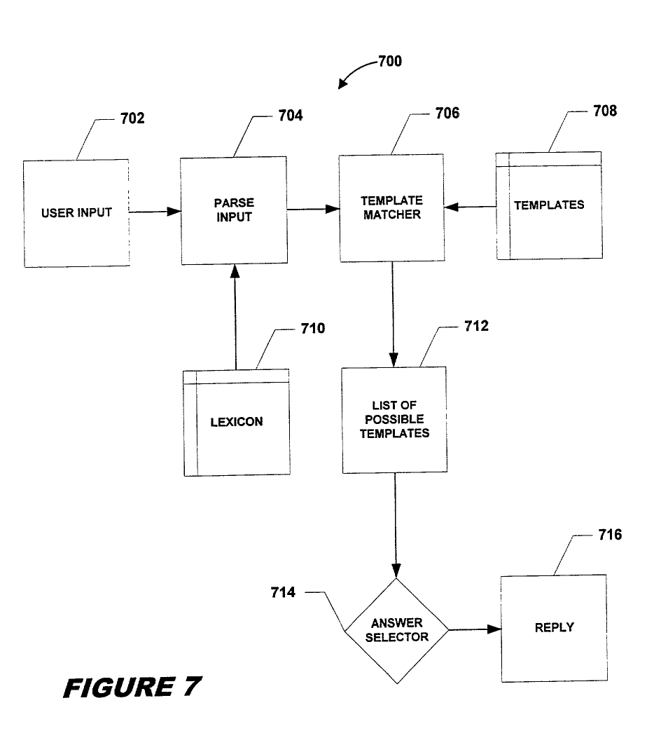

FIG. 7 is a process flow diagram illustrating a method for communication between a conversational agent 514 and a user. This communication method will typically be carried out by software residing in handset 100. In step 702, a user supplies a voice or text input request to handset 100 or, alternatively, to an appropriate device in communication with handset 100 (such as a website, for example). Agent 514 parses the user input (step 704) by analyzing the input syntax (i.e. breaking a sentence into its components) and using a lexicon hierarchy (block 710) of potential word meanings. For example, if the user says “find me a %restaurant,” the lexicon associated with the %restaurant might comprise Chinese, Japanese, and Mexican restaurants. The lexicon may be in hierarchical form, that is, the words most frequently used by the user would be at the top of potential meanings.

In step 706, agent 514 attempts to associate stored answer templates (block 708) with the parsed user input in order to develop a set or list 712 of possible answers. In the example above, the set of possible answers may comprise the following responses: (a) “What type of restaurant would you prefer”; (b) “Would you like me to find a Mexican restaurant (or Chinese, or Japanese)?” or (c) “Are you sure you are hungry?”

Agent 514 selects an answer from the list 9 (step 714) and responds to the user (step 716). If agent 514 knows (from the information stored in knowledge database 216) that Mexican food is the user's favorite, for example, agent 514 may select the answer “Would you like me to find a Mexican restaurant?” If a conversational agent is being used, the selected answer may first be transmitted to speech synthesizer service 520, where it is synthesized into speech. The synthesized speech is transmitted back to handset 100, where it is announced to the user. Alternatively, the selected answer could be displayed textually to the user, or a speech synthesis element could be incorporated directly into handset 100.

If in the above example, the user responds affirmatively, agent 514 requests the appropriate information from knowledge agency 206. When agency 206 receives the request, an individual knowledge agent 402 with expertise in restaurants will search for information on Mexican restaurants. Filters associated with knowledge agent 402 generate the best and nearest restaurants to the user and transmit the information to agent 514. Agent 514 may then respond in an open-ended fashion such as “Would you like me to give you directions to the nearest Mexican restaurant?” By using open-ended communication, agent 514 communicates in a natural way that is both useful and entertaining.

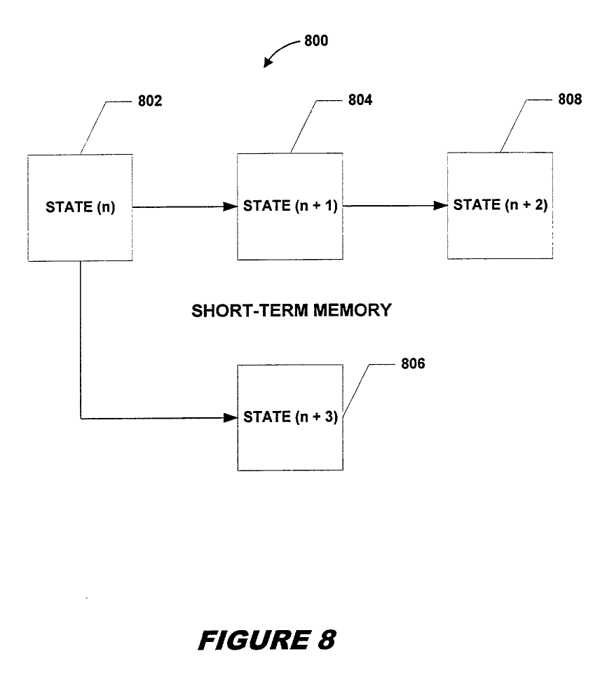

For such open-ended communication, some measure of dialog control is necessary. Dialog control is implemented using a combination of short-term memory, activation networks, sub-templates and use of personal pronouns. FIG. 8 illustrates one implementation of a short-term memory process 800. Conversational agent 514 begins at a state n (block 802), which represents a particular topic. Agent 514 then has the choice of starting the next dialog with one related topic, state n+1 (block 804), or another related topic, state n+3 (block 806). Many other choices will be present, but only two are illustrated for sake of brevity. Regardless of which choice is selected, agent 514 will retain in its short-term memory the topic of state n in case a return to that topic is necessary. From state n+1, for example, agent 514 may move onto state n+2 (block 808), and still retain in memory the original state n. There is, of course, a limit on the number of previous topics stored. Two are illustrated, but any appropriate number may be stored.

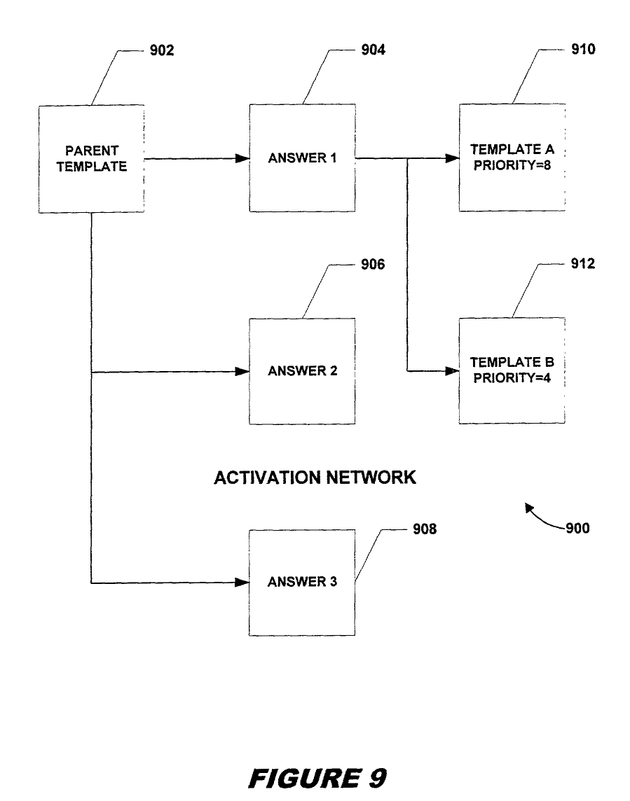

FIG. 9 illustrates one implementation of an activation network 900 for dialog control. When user input is received, activation network 900 increases the priority of relevant templates and decreases the priority of non-relevant templates that may be required for the next response. In effect, network 900 attempts to anticipate to the extent possible the user's reply, thereby facilitating a smooth and responsive conversation between the user and agent.

Once user input is received, activation network 900 selects a parent template 902 that includes a list of possible answers 904, 906, and 908 (see also FIG. 7 and related discussion). Each of these possible answers, in turn, has associated templates for a potential next reply to the user. Templates A and B (blocks 910 and 912), for example, are associated with answer 1 (block 904). Consider the scenario where the user input has led to the following answer 1: “So you are a member of our frequent flyer club?” Activation network 900 anticipates the user's next input and activates and prioritizes related templates. Template A is a reply related to frequent flyer benefits. Since the user has already indicated that he is a member of the frequent flyer club, this template will be activated and assigned a high priority (priority 8). Template B is a reply related to benefits in general. This template is also activated, but is assigned a lower priority (priority 4).

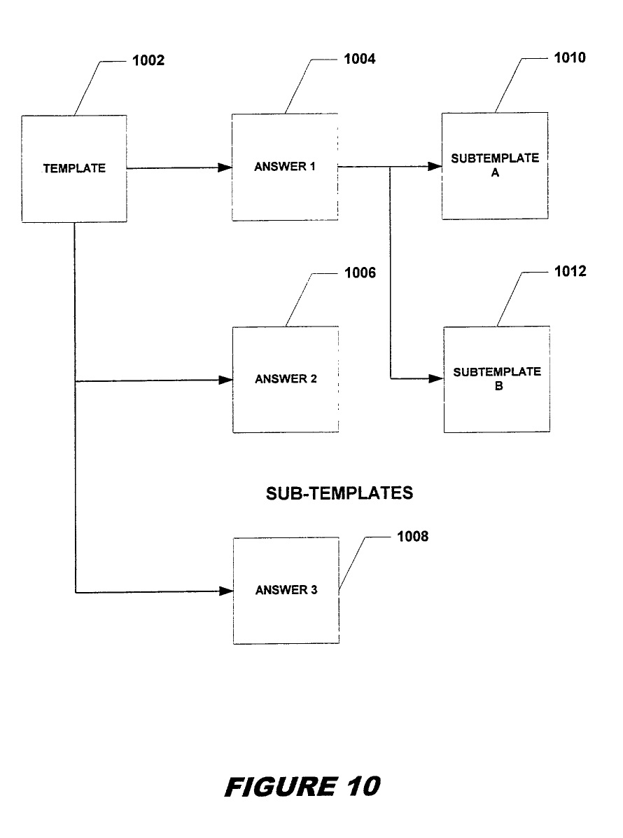

In a similar fashion, sub-templates within the activated templates may themselves be activated to anticipate user response (FIG. 10). In this case, once a parent template 1002 is selected with possible answers 1004, 1006, and 1008, sub-templates 1010 and 1012 in the scope of the parent template will be activated and prioritized. Insertion of personal pronouns (“you”, “I”, “he” and “she”), combined with the above techniques improves conversation further. In formulating a reply to the user input “Last night I went to the movie with Jack and Jill”, for example, “Jack” may be replaced with “he”, “Jill” may be replaced with “she”, “Jack and Jill” may be replaced with “they”, and “the movie” may be replaced for “it”. Hence, the agent's reply may be “Did they like it?”

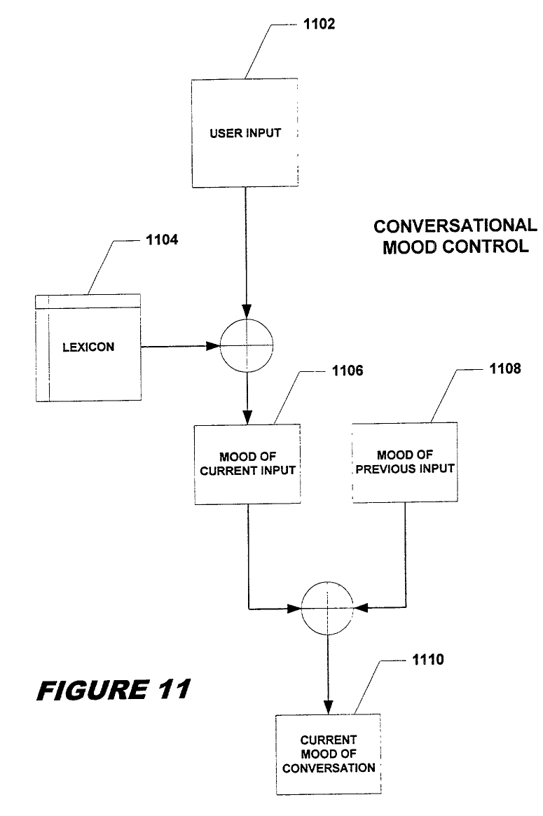

The agent may also assess the mood of the user input and select its reply accordingly. This is illustrated in FIG. 11. A user input 1102 is received and compared to a lexicon 1104 to determine whether any of the words in the user input are associated with particular moods. The mood of the current input (block 1106) is assessed relative to the mood of the previous input (block 1108) to arrive at a current mood (block 1110). This mood then effects what answers are selected and, therefore, what responses are provided to the user resulting in an overall mood of the conversation. By combining mood with dialog control and use of natural language, conversational agent 514 is able to converse with and entertain the user, as well as to retrieve targeted and relevant information.

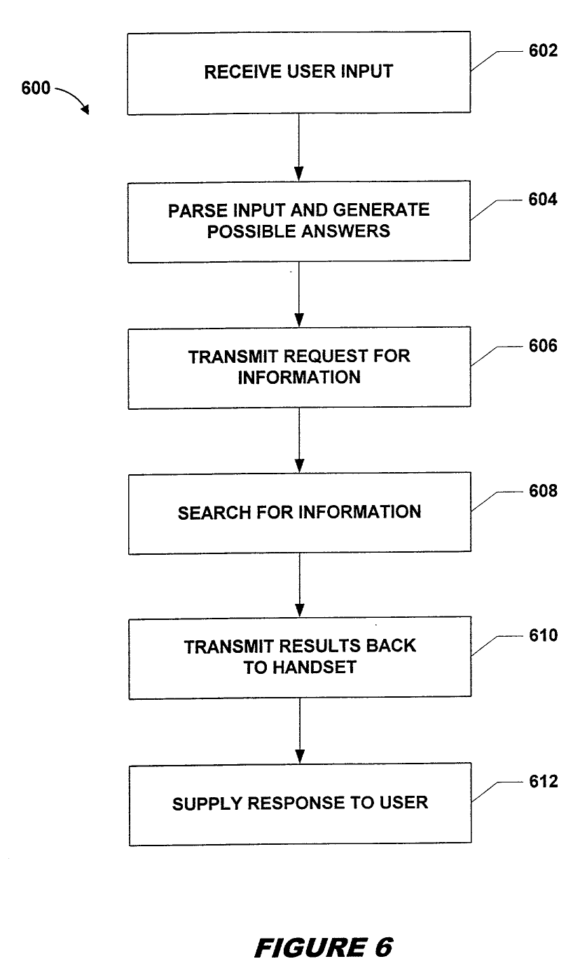

A method 600 for knowledge-based information retrieval is illustrated in FIG. 6. In step 602, a user of a wireless communication device inputs an information request. As described above, this request may be textual or voice and may directly into a handset 100 or into an associated communication device. In step 604, the user input is parsed and based on the parsed results, a list of possible answers is generated. If an appropriate answer cannot be determined, a default answer designed to elicit further information to resolve the request may be used.

In step 606, a request for information relevant to the selected answer is transmitted via a wireless communications network. In step 608, the request is serviced by a group of software programs designed to search electronic information databases for information related to specific topics or areas. The information retrieved is filtered for relevance to the specific user and transmitted back to the wireless communication device (step 610). In step 612, once the answer is completely formulated, the system responds to the user. The response may be a text response displayed on the wireless communication device, or it may be an audible response delivered via the communication device's audio interface.

While various embodiments of the present invention have been described above, it should be understood that these embodiments have been presented by way of example only, and not limitation. The breadth and scope of the present invention is not limited to any of the described embodiments, but rather, is defined in accordance with the following claims and their equivalents.

What we claim is:

1. A wireless communications system comprising:
at least one mobile communications device capable of having user requests input into it;
a remotely located knowledge agency having access to information that is responsive to user requests;
means for providing communication between the mobile communications device and the knowledge agency;
a knowledge database containing information associated with the mobile communications device, said information being useful for the generation of a response to a user request; and
a software agent adapted to access the information in the knowledge database and identify new information to be stored in the knowledge database.

2. The system of claim 1 wherein the mobile communications device further comprises a means for determining the position of the device.

3. The system of claim 2 wherein the position determining means comprises a GPS locator.

4. The system of claim 1 wherein the means for providing communication includes the Internet.

5. The system of claim 1 wherein the information is segregated into private information and public information.

6. The system of claim 1 wherein the information is segregated into private information, public information, and information collected by the software agent.

7. The system of claim 1 wherein the knowledge agency comprises a plurality of sub-agencies having expertise in different matters.

8. The system of claim 1 wherein the knowledge agency comprises a plurality of knowledge agents.

9. The system of claim 8 wherein at least one electronic database and at least one electronic directory are electronically accessible to the knowledge agency.

10. The system of claim 9 wherein at least one knowledge agent includes means to select response information from the electronic database based on a user request and information stored in the knowledge database.

11. The system of claim 1 further comprising a voice recognition device operatively linked to the mobile communications device.

12. The system of claim 11 further comprising means for generating a synthesized speech response to a voice request input into the mobile communications device.

13. A system for providing wireless communication between a mobile communications device and a remotely located knowledge agency, said system comprising:
at least one mobile communications device, said device including
means for transmitting and receiving wireless communications,
a knowledge database, and
means for accessing the knowledge database; and
means for providing a communication link between the mobile communications device and a remotely located knowledge agency.

14. The system of claim 13 wherein the mobile communications device further comprises a means for determining the position of the device.

15. The system of claim 14 wherein the position determining means comprises a GPS locator.

16. The system of claim 13 wherein the means for accessing the knowledge database comprises a software client agent.

17. The system of claim 13 wherein the communications link includes the Internet.

18. The system of claim 13 wherein the knowledge database includes private information and public information.

19. The system of claim 13 wherein the knowledge database includes a private database and a public database.

20. The system of claim 16 wherein the knowledge database includes information collected by the software client agent.

21. The system of claim 13 wherein the knowledge database includes an agent knowledge and personality database.

22. The system of claim 13 wherein the knowledge database includes private information, public information, and information collected by the means for accessing the knowledge database.

23. The system of claim 13 wherein the knowledge database includes a private database, a public database , and an agent knowledge and personality database.

24. The system of claim 13 wherein the knowledge agency comprises a plurality of sub-agencies having expertise in different matters.

25. The system of claim 13 wherein the knowledge agency comprises a plurality of knowledge agents.

26. The system of claim 25 further comprising at least one electronic database and at least one electronic directory that are electronically accessible to a knowledge agent.

27. The system of claim 25 wherein at least one knowledge agent includes means to access information from an electronic database based on a request received from the mobile device and information stored in the knowledge database.

28. The system of claim 25 wherein at least one knowledge agent includes means to access information from an electronic database based on a request received from a mobile device and stored ratings information relating to the request.

29. The system of claim 13 wherein the mobile device further comprises a voice recognition device.

30. The system of claim 29 wherein the mobile device further comprises means for generating a synthesized speech response to a voice request input into the mobile device.

31. The system of claim 13 wherein the mobile device further comprises means for generating a response to a request input into the mobile device.

32. The system of claim 13 wherein the knowledge agency comprises a voice recognition device.

33. The system of claim 32 wherein the knowledge agency comprises means for generating a synthesized speech response to a voice request input into the mobile device.

34. A method of providing information responsive to a user request using a wireless communications system, said method comprising the steps of:
inputting a request into a mobile communications device, said request containing content capable of being characterized;
accessing user information stored in a knowledge database based on the request content;
providing selected user information and the request content to a knowledge agency;
accessing response information based on the selected user information and the request content; and
generating a response to the request based on the accessed response information.

35. The method of claim 34 wherein the user information comprises information selected from the group consisting of: private information, public information, personality information, and location information.

36. The method of claim 34 wherein the user information comprises private information, public information, personality information, and location information.

37. The method of claim 34 wherein the step of accessing user information stored in a knowledge database comprises the steps of:
providing the request to a software agent;
using the software agent to parse the request to identify the request content;
using the software agent to access user information from the knowledge database; and
using the software agent to select user information based on the request content.

38. The method of claim 37 wherein the software agent resides in a mobile wireless communications device.

39. The method of claim 38 wherein the knowledge database resides in the mobile wireless communications device.

40. The method of claim 34 wherein the knowledge database resides in a mobile wireless communications device.

41. The method of claim 34 wherein the step of providing selected user information and the request content to a knowledge agency comprises the steps of:
transmitting the selected user information from a mobile wireless communications device to a base station; and
transmitting the selected user information from the base station to the knowledge agency over a link that includes the Internet.

42. The method of claim 41 wherein the step of accessing user information stored in a knowledge database comprises the steps of:
providing the request to a software agent residing in the mobile wireless communications device;
using the software agent to parse the request to identify the request content;
using the software agent to access user information from the knowledge database residing in the mobile wireless communications device; and
using the software agent to select user information based on the request content.

43. The method of claim 34 wherein the step of accessing response information comprises the steps of:
providing the selected user information and the request content to one or more selected knowledge agents within the knowledge agency; and
using the knowledge agents to access the response information.

44. The method of claim 34 wherein the step of generating a response to the request comprises the steps of:
filtering the response information to identify the most appropriate response information; and
interjecting the most appropriate response information into a prestored answer template to generate the response.

45. A knowledge-based information retrieval system comprising:
a wireless communications network;
a wireless communications device operating within the network and comprising a transceiver that sends and receives communications across the network, a software client agent that receives an information request from a user of the device and retrieves information responsive to the request, a position determination device that determines the location of the wireless device and provides the location to the client agent to assist in information retrieval, and a knowledge database containing data of use to the client agent in information retrieval; and
a knowledge agency comprising multiple knowledge agents that communicate with the client agent over the wireless network and that access associated information resources to retrieve information that is responsive to the information request.

46. The information retrieval system of claim 45 wherein the knowledge database comprises:
a private database that stores private information about the user;
a public database that stores public information about the user; and
an agent knowledge database that stores information retrieved and developed by the client agent.

47. The information retrieval system of claim 46, wherein
the private database stores at least one item selected from a group consisting of: the user's name, social security number, contacts, schedule, passwords, account information, and passwords;
the public database stores at least one item selected from a group consisting of user preferences, item ratings, user interests, user needs, and the location of the wireless device; and
the agent knowledge database stores at least one item selected from the group consisting of information related to the user's mood and other information learned by the client agent about the user and the user's preferences.

48. The information retrieval system of claim 45 wherein the position determination device is a GPS receiver.

49. The information retrieval system of claim 45 further comprising a collaborative filter for refining the information retrieved by the knowledge agents.

50. The information retrieval system of claim 45, wherein the wireless device further comprises an audio processor and a voice recognition device for receiving voice input from the user and converting the input into digital data for use by the client agent, and a speech synthesis device for synthesized the retrieved information into voice data for announcement to the user.

51. The information retrieval system of claim 45, wherein the information request is parsed by the agent and matched with possible answers.

52. The information retrieval system of claim 51, wherein parsing involves analysis of the syntax of the information request and comparison with a lexicon hierarchy of word meanings.

53. The information retrieval system of claim 45 further comprising means for controlling a conversational dialog between the user and the client agent.

54. The information retrieval system of claim 53, wherein the dialog control means comprises:
a short-term memory permitting the client agent to access a previous topic when responding to the user or to access another next topic;
templates of anticipated responses to the next user input; and
an activation network that increases and decreases the priorities of the templates based on relevancy.

55. A method for knowledge-based information retrieval in a wireless communications system comprising the following steps:
(a) receiving an information request from a user of a wireless communications device;
(b) providing the information request to a software agent associated with the wireless communications device;
(c) providing data of relevance to the information request to the software agent;
(d) with the software agent, communicating the information request via the wireless network to a knowledge agency comprised of specialized knowledge agents;
(e) with the knowledge agency, searching appropriate information resources to retrieve information responsive to the information request;
(f) with the knowledge agency, communicating the retrieved information via the network to the software agent; and
(g) providing the retrieved information to the user of the wireless device.

56. The method of claim 55, wherein in step (c) the data of relevance includes the location of the wireless device and user preferences stored on the wireless device.

57. The method of claim 55, wherein the knowledge agency resides on a server connected to the Internet and in step (e) the information resources include electronic databases and directories.

58. A method for controlling dialog between a software agent associated with a wireless communications device and a user of the device comprising the following steps:
(a) receiving an input from the user;
(b) parsing the input;
(c) retrieving a list of potential replies to the input from stored templates and selecting a reply;
(d) initiating communication between the software agent and an outside knowledge agency to retrieve any information necessary to complete the reply; and
(e) providing the completed reply to the user.

59. The method of claim 58, wherein step (b) comprises analyzing the syntax of the user input and comparing the syntax to a lexicon hierarchy of potential word meanings.

60. The method of claim 58, wherein step (a) comprises receiving a voice input from the user and converting the voice input into digital form, and step (e) comprises converting a digital reply into a voice reply that is provided to the user.

61. The method of claim 58, wherein step (c) further comprises activating templates for potential replies to the next user input, and assigning priorities to the templates according to the current user input.

62. The method of claim 58, wherein in step (c) the current conversational mood is assessed before selecting a reply.

63. The method of claim 62, wherein the current conversational mood is assessed by comparing the current input to a lexicon to generate the mood of the current input, and comparing the mood of the current input to the mood of the previous input to generate a current conversational mood.
